(19) United States
(12) Patent Application Publication
(10) Pub. No.: US 2024/0284320 A1
(43) Pub. Date: Aug. 22, 2024

(54) NETWORK SLICING BASED VPLMN PRIORITIZATION

(71) Applicant: Telefonaktiebolaget LM Ericsson (publ), Stockholm (SE)

(72) Inventors: George Foti, Dollard des Ormeaux (CA); Peter Hedman, Helsingborg (SE)

(21) Appl. No.: 18/689,197

(22) PCT Filed: Sep. 7, 2022
(86) PCT No.: PCT/IB2022/058426

§ 371 Date: Mar. 5, 2024

Related U.S. Application Data
(60) Provisional application No. 63/241,286, filed on Sep. 7, 2021.

(51) Int. Cl. H04W 48/18; H04W 24/02; H04W 48/04

(52) U.S. Cl. CPC H04W 48/18; H04W 24/02; H04W 48/04

(57) ABSTRACT

Systems and methods are disclosed for network slicing based visited or non-public network prioritization. In one embodiment, a method performed by a first Network Function (NF) in a home network of a wireless communication device in a roaming scenario comprises obtaining Steering of Roaming (SoR) information for the wireless communication device, the SoR information comprising a prioritized list of visited or non-public networks that are prioritized based on one or more network slices requested by the wireless communication device and/or one or more network slices to which the wireless communication device is subscribed. The method further comprises sending, towards the wireless communication device, a message comprising the SoR information. Embodiments of a first NF, embodiments of a second NF in the visited or non-public network and methods of operation thereof, and embodiments of a wireless communication device and method of operation thereof are also disclosed.

### RELATED APPLICATIONS

This application claims the benefit of provisional patent application Ser. No. 63/241,286, filed Sep. 7, 2021, the disclosure of which is hereby incorporated herein by reference in its entirety.

### TECHNICAL FIELD

The present disclosure relates to Visited Public Land Mobile Network (VPLMN) prioritization.

### BACKGROUND

In a Third Generation Partnership Project (3GPP) system, while roaming, a User Equipment (UE) may camp on a Visited Public Land Mobile Network (VPLMN) that cannot support all the network slices (i.e., network slices indicated by respective Serving Network Slice Assistance Informations (S-NSSAIs)) for which the UE is a subscriber in the whole VPLMN or in certain areas of the VPLMN. The UE will ascertain from the Allowed S-NSSAIs, rejected S-NSSAIs, and configured S-NSSAIs that some of the S-NSSAIs of the Home Public Land Mobile Network (HPLMN) are not available.

While roaming, the Unified Data Management (UDM) may adapt which Subscribed S-NSSAIs the UDM sends to the Access and Mobility Management Function (AMF), e.g. based on Service Level Agreement (SLA) between the two networks/PLMNs, i.e. it may be that different Visited PLMNs get different Subscribed S-NSSAIs when the UE roams.

While roaming, the UE typically selects the VPLMN based on PLMN selection information, e.g. “HPLMN Selector with Access Technology”, “User Controlled PLMN Selector with Access Technology”, “Forbidden PLMNs”, “Equivalent HPLMN” as described in 3GPP Technical Specification (TS) 23.122 V17.3.0.

A UE may be able to access more than one network/PLMN at the same time. For example, a UE may use one HPLMN subscription to access two different VPLMNs—one VPLMN using 3GPP access and another VPLMN using non-3GPP access.

An extension of the HPLMN provided “HPLMN Selector with Access Technology” with S-NSSAIs supported per VPLMN has been proposed.

Extensions of Radio Resource Control (RRC) System Information Broadcast (SIB) with network slices (S-NSSAIs) supported by the cell, Tracking Area (TA), or PLMN have also been proposed.

### SUMMARY

Systems and methods are disclosed for network slicing based Visited Public Land Mobile Network (VPLMN) or Serving Non-Public Network (SNPN) prioritization. In one embodiment, a method comprises, at a first Network Function (NF) in a home network of a wireless communication device in a roaming scenario, obtaining Steering of Roaming (SoR) information for a wireless communication device, where the SOR information comprises a prioritized list of visited or non-public networks for the wireless communication device and visited or non-public networks comprised in the prioritized list are prioritized based on one or more network slices requested by the wireless communication device and/or one or more network slices to which the wireless communication device is subscribed. The method further comprises, at the first NF, sending, to a second NF in a visited or non-public network of the wireless communication device, a message comprising the SoR information for the wireless communication device. The method further comprises, at the second NF, receiving the message comprising the SoR information for the wireless communication device and sending a message to the wireless communication device comprising the SoR information for the wireless communication device. The method further comprises, at the wireless communication device, receiving the message from the second NF and performing one or more actions based on the SoR information. In this manner, the home network is enabled to control what roaming partners (i.e., visited networks) the wireless communication device should use when wanting certain network slices, taking into account additional information not available today, e.g. wireless communication device capabilities, requested network slices, etc.

In one embodiment, the SOR information further comprises, for each visited or non-public network comprised in the prioritized list, information that indicates one or more network slices supported by the visited or non-public network.

In one embodiment, the SoR information further comprises, for each visited or non-public network comprised in the prioritized list, information that indicates one or more network slices of a home network of the wireless communication device that are supported by the visited or non-public network.

In one embodiment, the SoR information further comprises validity information that indicates one or more conditions under which the SOR information is valid.

In one embodiment, the SoR information further comprises validity information that indicates a time during which the SoR information is valid.

In one embodiment, the SoR information further comprises validity information that indicates a geographic area in which the SoR information is valid.

In one embodiment, the method further comprises, at the wireless communication device, storing the message received from the second NF.

In one embodiment, the SoR information is comprised in a transparent container such that the SoR information is transparent to the second NF.

In one embodiment, at the first NF, obtaining the SoR information comprises sending, to a third NF in the home network of the wireless communication device, a request comprising: (a) an identifier of the visited network or non-public network of the wireless communication device, (b) a geographic location of the wireless communication device, (c) information that indicates the one or more network slices requested by the wireless communication device, (d) information that indicates the one or more network slices to which the wireless communication device is subscribed, (e) information that indicates the one or more network slices requested by the wireless communication device that are not supported by the visited network or non-public network of the wireless communication device, (f) information that indicates the one or more network slices to which the wireless communication device is subscribed that are not supported by the visited network or non-public network of the wireless communication device, (g) information that indicates a capability of the wireless communication device for registration to more than one network, (h) information that indicates one or more capabilities of the wireless communication devices related to its ability to handle enhanced SoR information, (i) information that indicates one or more capabilities of the wireless communication device to provide additional information to the network, the additional information including information that indicates one or more network slices requested by the wireless communication device, or (j) a combination of any two or more of (a)-(i). Obtaining the SoR information further comprises receiving, from the third NF, a response comprising the SoR information.

In one embodiment, the method further comprises, at the third NF, receiving the request from the first NF and, responsive to receiving the request from the first NF, generating SoR information comprising the prioritized list of visited or non-public networks.

In one embodiment, the prioritized list of visited or non-public networks is prioritized based on whether the visited or non-public networks support all of the subscribed network slices and/or all of the requested network slices. In one embodiment, the prioritized list of visited or non-public networks is further prioritized based on preference of the home network.

In one embodiment, the prioritized list of visited or non-public networks is prioritized based on priorities assigned to the network slices.

In one embodiment, the prioritized list of visited or non-public networks is prioritized such that visited or non-public networks supports all of the one or more network slices to which the wireless communication device is subscribed or at least all of the one or more network slices requested by the wireless communication device are prioritized in order of preference of the home network. In one embodiment, the wireless communication device does not support registration in more than one network at the same time or there is no further network available to the wireless communication device that supports all of the one or more network slices to which the wireless communication device is subscribed or at least all of the one or more network slices requested by the wireless communication device, and the prioritized list of visited or non-public networks next prioritizes visited or non-public networks supports at least a (e.g., predefined or configured) threshold amount of the one or more network slices to which the wireless communication device is subscribed or the one or more network slices requested by the wireless communication device. In another embodiment, the wireless communication device supports registration in more than one network at the same time, and the prioritized list of visited or non-public networks next prioritizes visited or non-public networks that support at least one network slice requested by or subscribed to by the wireless communication device that is not supported by the visited or non-public network of the wireless communication device.

In one embodiment, the method further comprises, at the first NF, determining that at least one subscribed network slice of the wireless communication device is not available to the wireless communication device in the visited network or non-public network in which the wireless communication device is currently located.

In one embodiment, the method further comprises, at the first NF, receiving, via the second network function in the visited network or non-public network, a container comprising information that indicates: (i) the one or more network slices requested by the wireless communication device, (ii) a capability of the wireless communication device related to handling of enhanced SoR information, (iii) a location of the wireless communication device, or (iv) a combination of any two or more of (i)-(iii). In one embodiment, the container is received in association a registration procedure in which the wireless communication device requests registration with the visited or non-public network in which the wireless communication device is located.

In one embodiment, the method further comprises, at the first NF, receiving, via the second network function in the visited network or non-public network, information that indicates what SoR information is stored at the wireless communication device. In one embodiment, a determination is made, in the home network, of whether SoR information stored at the wireless communication device needs to be updated based on the information that indicates what SoR information is stored at the wireless communication device.

Embodiments of method performed by a first NF in a home network of a wireless communication device in a roaming scenario are also disclosed. In one embodiment, a method performed by a first NF in a home network of a wireless communication device in a roaming scenario comprises obtaining SoR information for the wireless communication device, the SoR information comprising a prioritized list of visited or non-public networks that are prioritized based on one or more network slices requested by the wireless communication device and/or one or more network slices to which the wireless communication device is subscribed. The method further comprises sending, towards the wireless communication device, a message comprising the SoR information.

In one embodiment, the SOR information further comprises, for each visited or non-public network comprised in the prioritized list, information that indicates one or more network slices supported by the visited or non-public network.

In one embodiment, the SoR information further comprises, for each visited or non-public network comprised in the prioritized list, information that indicates one or more network slices of a home network of the wireless communication device that are supported by the visited or non-public network.

In one embodiment, the SoR information further comprises validity information that indicates one or more conditions under which the SoR information is valid.

In one embodiment, the SoR information further comprises validity information that indicates a time during which the SoR information is valid.

In one embodiment, the SOR information further comprises validity information that indicates a geographic area in which the SoR information is valid.

In one embodiment, the SoR information is comprised in a transparent container such that the SoR information is transparent to the second NF.

In one embodiment, obtaining the SoR information comprises sending, to a second NF in the home network of the wireless communication device, a request comprising: (a) an identifier of the visited network or non-public network of the wireless communication device, (b) a geographic location of the wireless communication device, (c) information that indicates the one or more network slices requested by the wireless communication device, (d) information that indicates the one or more network slices to which the wireless communication device is subscribed, (e) information that indicates the one or more network slices requested by the wireless communication device that are not supported by the visited network or non-public network of the wireless communication device, (f) information that indicates the one or more network slices to which the wireless communication device is subscribed that are not supported by the visited network or non-public network of the wireless communication device, (g) information that indicates a capability of the wireless communication device for registration to more than one network, (h) information that indicates one or more capabilities of the wireless communication devices related to its ability to handle enhanced SoR information, (i) information that indicates one or more capabilities of the wireless communication device to provide additional information to the network, the additional information including information that indicates one or more network slices requested by the wireless communication device, or (j) a combination of any two or more of (a)-(i). Obtaining the SoR information further comprises receiving, from the second NF, a response comprising the SoR information.

In one embodiment, the method further comprises determining that at least one subscribed network slice of the wireless communication device is not available to the wireless communication device in the visited network or non-public network in which the wireless communication device is currently located.

In one embodiment, the method further comprises receiving, via a third network function in the visited network or non-public network in which the wireless communication device is currently located, a container comprising information that indicates: (i) the one or more network slices requested by the wireless communication device, (ii) a capability of the wireless communication device related to handling of enhanced SoR information, (iii) a location of the wireless communication device, or (iv) a combination of any two or more of (i)-(iii). In one embodiment, the container is received in association a registration procedure in which the wireless communication device requests registration with the visited or non-public network in which the wireless communication device is located.

In one embodiment, obtaining the SOR information and sending, towards the wireless communication device, the message comprising the SoR information are performed subsequent to registration of the wireless communication device with the visited network or non-public network in which the wireless communication device is currently located. In one embodiment, the method further comprises determining or obtaining information about a capability of the wireless communication device to handle enhanced SoR information.

In one embodiment, the method further comprises determining whether the wireless communication device is capable of handling enhanced SoR information.

In one embodiment, the method further comprises receiving, via the second network function in the visited network or non-public network, information that indicates what SoR information is stored at the wireless communication device. In one embodiment, a determination is made, in the home network, of whether SoR information stored at the wireless communication device needs to be updated based on the information that indicates what SoR information is stored at the wireless communication device.

Corresponding embodiments of a first NF are also disclosed. In one embodiment, a first NF in a home network of a wireless communication device in a roaming scenario is adapted to obtain SoR information for the wireless communication device, the SoR information comprising a prioritized list of visited or non-public networks that are prioritized based on one or more network slices requested by the wireless communication device and/or one or more network slices to which the wireless communication device is subscribed. The first NF is further adapted to send, towards the wireless communication device, a message comprising the SoR information.

In one embodiment, a network node for implementing a first NF in a home network of a wireless communication device in a roaming scenario comprises processing circuitry configured to cause the network node to obtain SoR information for the wireless communication device, the SoR information comprising a prioritized list of visited or non-public networks that are prioritized based on one or more network slices requested by the wireless communication device and/or one or more network slices to which the wireless communication device is subscribed. The processing circuitry is further configured to cause the network node to send, towards the wireless communication device, a message comprising the SoR information.

In one embodiment, a method performed by a first NF associated to a home network of a wireless communication device in a roaming scenario comprises receiving, from a second NF in the home network of the wireless communication device, a request comprising: (a) an identifier of the visited network or non-public network of the wireless communication device, (b) a geographic location of the wireless communication device, (c) information that indicates the one or more network slices requested by the wireless communication device, (d) information that indicates the one or more network slices to which the wireless communication device is subscribed, (e) information that indicates the one or more network slices requested by the wireless communication device that are not supported by the visited network or non-public network of the wireless communication device, (f) information that indicates the one or more network slices to which the wireless communication device is subscribed that are not supported by the visited network or non-public network of the wireless communication device, (g) information that indicates a capability of the wireless communication device for registration to more than one network, (h) information that indicates one or more capabilities of the wireless communication devices related to its ability to handle enhanced SoR information, (i) information that indicates one or more capabilities of the wireless communication device to provide additional information to the network, the additional information including information that indicates one or more network slices requested by the wireless communication device, or (j) a combination of any two or more of (a)-(i). The method further comprises generating SoR information for the wireless communication device, the SoR information comprising a prioritized list of visited or non-public networks for the wireless communication device, where visited or non-public networks comprised in the prioritized list are prioritized based on the one or more network slices requested by the wireless communication device and/or the one or more network slices to which the wireless communication device is subscribed. The method further comprises sending, to the second NF, a response comprising the prioritized list of visited or non-public networks.

In one embodiment, the SoR information further comprises, for each visited or non-public network comprised in the prioritized list, information that indicates one or more network slices supported by the visited or non-public network.

In one embodiment, the SoR information further comprises, for each visited or non-public network comprised in the prioritized list, information that indicates one or more network slices of a home network of the wireless communication device that are supported by the visited or non-public network.

In one embodiment, the SoR information further comprises validity information that indicates one or more conditions under which the SoR information is valid.

In one embodiment, the SOR information further comprises validity information that indicates a time during which the SoR information is valid.

In one embodiment, the SoR information further comprises validity information that indicates a geographic area in which the SoR information is valid.

Corresponding embodiments of a first NF are also disclosed. In one embodiment, a first NF associated to a home network of a wireless communication device in a roaming scenario is adapted to receive, from a second NF in the home network of the wireless communication device, a request comprising: (a) an identifier of the visited network or non-public network of the wireless communication device, (b) a geographic location of the wireless communication device, (c) information that indicates the one or more network slices requested by the wireless communication device, (d) information that indicates the one or more network slices to which the wireless communication device is subscribed, (e) information that indicates the one or more network slices requested by the wireless communication device that are not supported by the visited network or non-public network of the wireless communication device, (f) information that indicates the one or more network slices to which the wireless communication device is subscribed that are not supported by the visited network or non-public network of the wireless communication device, (g) information that indicates a capability of the wireless communication device for registration to more than one network, (h) information that indicates one or more capabilities of the wireless communication devices related to its ability to handle enhanced SoR information, (i) information that indicates one or more capabilities of the wireless communication device to provide additional information to the network, the additional information including information that indicates one or more network slices requested by the wireless communication device, or (j) a combination of any two or more of (a)-(i). The first NF is further adapted to generate SoR information for the wireless communication device, the SoR information comprising a prioritized list of visited or non-public networks for the wireless communication device, where visited or non-public networks comprised in the prioritized list are prioritized based on the one or more network slices requested by the wireless communication device and/or the one or more network slices to which the wireless communication device is subscribed. The first NF is further adapted to send, to the second NF, a response comprising the prioritized list of visited or non-public networks.

In one embodiment, a network node for implementing a first NF associated to a home network of a wireless communication device in a roaming scenario comprises processing circuitry configured to cause the network node to receive, from a second NF in the home network of the wireless communication device, a request comprising: (a) an identifier of the visited network or non-public network of the wireless communication device, (b) a geographic location of the wireless communication device, (c) information that indicates the one or more network slices requested by the wireless communication device, (d) information that indicates the one or more network slices to which the wireless communication device is subscribed, (e) information that indicates the one or more network slices requested by the wireless communication device that are not supported by the visited network or non-public network of the wireless communication device, (f) information that indicates the one or more network slices to which the wireless communication device is subscribed that are not supported by the visited network or non-public network of the wireless communication device, (g) information that indicates a capability of the wireless communication device for registration to more than one network, (h) information that indicates one or more capabilities of the wireless communication devices related to its ability to handle enhanced SoR information, (i) information that indicates one or more capabilities of the wireless communication device to provide additional information to the network, the additional information including information that indicates one or more network slices requested by the wireless communication device, or (j) a combination of any two or more of (a)-(i). The processing circuitry is further configured to cause the network node to generate SoR information for the wireless communication device, the SoR information comprising a prioritized list of visited or non-public networks for the wireless communication device, where visited or non-public networks comprised in the prioritized list are prioritized based on the one or more network slices requested by the wireless communication device and/or the one or more network slices to which the wireless communication device is subscribed. The processing circuitry is further configured to cause the network node to send, to the second NF, a response comprising the prioritized list of visited or non-public networks.

Embodiments of a method performed by a wireless communication device are also disclosed. In one embodiment, a method performed by a wireless communication device comprises receiving a message from a NF of a visited network of the wireless communication device, the message comprising SoR information that comprises a prioritized list of visited or non-public networks for the wireless communication device, where visited or non-public networks comprised in the prioritized list are prioritized based on one or more network slices requested by the wireless communication device and/or one or more network slices to which the wireless communication device is subscribed. The method further comprises performing one or more actions based on the prioritized list of visited or non-public networks.

In one embodiment, the SoR information further comprises, for each visited or non-public network comprised in the prioritized list, information that indicates one or more network slices supported by the visited or non-public network.

In one embodiment, the SoR information further comprises, for each visited or non-public network comprised in the prioritized list, information that indicates one or more network slices of a home network of the wireless communication device that are supported by the visited or non-public network.

In one embodiment, the SOR information further comprises validity information that indicates one or more conditions under which the SoR information is valid.

In one embodiment, the SoR information further comprises validity information that indicates a time during which the SoR information is valid.

In one embodiment, the SOR information further comprises validity information that indicates a geographic area in which the SoR information is valid.

In one embodiment, the method further comprises sending, to the NF, a registration request message comprising: (a) information that indicates one or more capabilities of the wireless communication device related to enhanced SoR information, (b) information that indicates a geographic location of the wireless communication device, (c) information that indicates the one or more network slices requested by the wireless communication device, or (d) a combination of any two or more of (a)-(c), wherein receiving the message comprising the SoR information comprises receiving a registration accept message from the NF comprising the SoR information.

In one embodiment, the method further comprises sending, to the NF, a message comprising: (a) information that indicates one or more capabilities of the wireless communication device related enhanced SoR information, (b) information that indicates a geographic location of the wireless communication device, (c) information that indicates the one or more network slices requested by the wireless communication device, or (d) a combination of any two or more of (a)-(c).

In one embodiment, the method further comprises, as part of a User Equipment (UE) configuration update procedure, sending, to the NF, an uplink (UL) Non-Access Stratum (NAS) transport message comprising: (a) information that indicates one or more capabilities of the wireless communication device related to its ability to handle a list of prioritized visited or non-public networks, (b) information that indicates a geographic location of the wireless communication device, (c) information that indicates the one or more network slices requested by the wireless communication device, or (d) a combination of any two or more of (a)-(c).

In one embodiment, the method further comprises sending, to the NF in the visited network or non-public network, information that indicates what SoR information is stored at the wireless communication device.

Corresponding embodiments of a wireless communication device are also disclosed. In one embodiment, a wireless communication device is adapted to receive a message from a NF of a visited network of the wireless communication device, the message comprising SoR information that comprises a prioritized list of visited or non-public networks for the wireless communication device, where visited or non-public networks comprised in the prioritized list are prioritized based on one or more network slices requested by the wireless communication device and/or one or more network slices to which the wireless communication device is subscribed. The wireless communication device is further adapted to perform one or more actions based on the prioritized list of visited or non-public networks.

In one embodiment, a wireless communication device comprises one or more transmitters, one or more receivers, and processing circuitry associated with the one or more transmitters and the one or more receivers. The processing circuitry is configured to cause the wireless communication device to receive a message from a NF of a visited network of the wireless communication device, the message comprising SoR information that comprises a prioritized list of visited or non-public networks for the wireless communication device, where visited or non-public networks comprised in the prioritized list are prioritized based on one or more network slices requested by the wireless communication device and/or one or more network slices to which the wireless communication device is subscribed. The processing circuitry is further configured to cause the wireless communication device to perform one or more actions based on the prioritized list of visited or non-public networks.

In another embodiment, a method comprises, at a wireless communication device, sending, to a first NF in a visited or non-public network of the wireless communication device, a registration request that comprises: (a) information that indicates one or more capabilities of the wireless communication device related to its ability to handle a list of prioritized visited or non-public networks, (b) information that indicates a geographic location of the wireless communication device, (c) information that indicates the one or more network slices requested by the wireless communication device, or (d) a combination of any two or more of (a)-(c). The method further comprises, at the first NF, receiving the registration request and initiating a procedure by which one or more policies are derived for the wireless communication device based on the information comprised in the registration request and sent to the wireless communication device. The method further comprises, at the wireless communication device, receiving the one or more policies and using the one or more policies to decide whether to: reselect to another visited or non-public network in order to access one or more network slices (e.g., one or more requested network slices and/or one or more subscribed network slices), or additionally register to another visited or non-public network in order to access at least one network slice (e.g., at least one requested or subscribed network slice) while also maintaining a current registration with the visited or non-public network.

In one embodiment, the one or more polices comprise a network ID to which each of one or more rules (e.g., one or more UE Route Selection Policies (URSPs)) is applicable.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure;

FIG. 2 illustrates example embodiments in which the cellular communication system of FIG. 1 is a Fifth Generation (5G) System (5GS);

FIGS. 3A and 3B illustrate a procedure in accordance with one embodiment of the present disclosure;

FIGS. 4A and 4B illustrate a procedure in accordance with another embodiment of the present disclosure;

FIG. 5 illustrates a procedure in accordance with another embodiment of the present disclosure;

FIGS. 6, 7, and 8 are schematic block diagrams of example embodiments of a network node; and

FIGS. 9 and 10 are schematic block diagrams of example embodiments of a wireless communication device (e.g., a User Equipment device (UE)).

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There are problems associated with existing solutions. Currently, there is no defined solution that enables a roaming UE to find and register to a visited network (e.g., Visited Public Land Mobile Network (VPLMN)) that best serves the UE considering: (a) the network slices (e.g., Serving Network Slice Assistance Information(s) (S-NSSAI(s)) the UE's subscription allows for the visited network and the network slices that the UE wants to use and (b) the area (e.g., geographic area) in which the UE is located. For example, the following problems exist with existing solutions:
Providing S-NSSAIs in the System Information Broadcast (SIB) may put too high load on the Radio Resource Control (RRC) broadcast channel.
Extending the Home Public Land Mobile Network (HPLMN) provided “HPLMN Selector with Access Technology” with S-NSSAIs supported per VPLMN will not cover parts of the VPLMN (i.e., will not be able to cover areas of the VPLMN with different network slice availability) and is not dynamic enough as the HPLMN in principle only has the Service Level agreement (SLA) between the VPLMN and the HPLMN as basis for providing updates of the “HPLMN Selector with Access Technology” to the UE.

Systems and methods are disclosed herein that address the aforementioned and/or other problems. Embodiments disclosed herein address the aforementioned short comings by providing, to a roaming a UE, real-time information while roaming regarding VPLMNs that can support the UE's subscribed S-NSSAI(s). In one embodiment, the UE has two or more subscribed S-NSSAIs, and none of the existing VPLMNs can fulfill all of the UE's subscribed S-NSSAIs. In one embodiment, the information is provided when none of the existing VPLMNs can fulfill all of the UE's subscribed S-NSSAIS.

In one embodiment, the HPLMN (or more generally subscription holder, e.g., HPLMN or Credential Holder (CH)) maintains a list of VPLMNs and the S-NSSAIs they support. At registration, the HPLMN returns, to the UE, a list of VPLMNs based on what S-NSSAIs they support and based on the subscribed S-NSSAI(s) of the UE. In one embodiment, the list of VPLMNs is prioritized. More than one option is proposed herein for the HPLMN to return such a list to the UE.

In one embodiment, when the UE receives this new VPLMN list, the UE selects one or more VPLMNs from the list (e.g., based on the S-NSSAIs supported by the VPLMNs in the list and the subscribed S-NSSAI(s) of the UE) and registers to the one or more selected VPLMNs (e.g., at the same time) to acquire the needed services and S-NSSAI(s) that the UE needs.

In one embodiment, the HPLMN enables this mutual registration by supporting different instances for a registered UE context information-one per VPLMN. In one embodiment, this is done by extending service operations to include the VPLMN attribute.

Optionally the HPLMN can determine the visited domain at registration. However, Network Exposure Function (NEF) operations may need to be extended with VPLMN as an additional attribute.

The proposed options to return the new VPLMN list are discussed in more detail below.

While not being limited to or by any particular advantage. Embodiments of the systems and method disclosed herein may provide a number of advantages over the existing solutions. Embodiments of the present disclosure provide a solution that enables the HPLMN to dynamically, and in real-time, control, taking into account additional information not available today, e.g. UE capabilities, requested network slices, what roaming partners (i.e., VPLMNs) the UE should use when wanting certain network slices. Embodiments of the present disclosure avoid the need for the network to extend the RRC SIB. In addition, embodiments of the present disclosure do not require provisioning the UE in advance with information about all the HPLMN roaming partners (VPLMNs and the S-NSSAIs that the VPLMNs support).

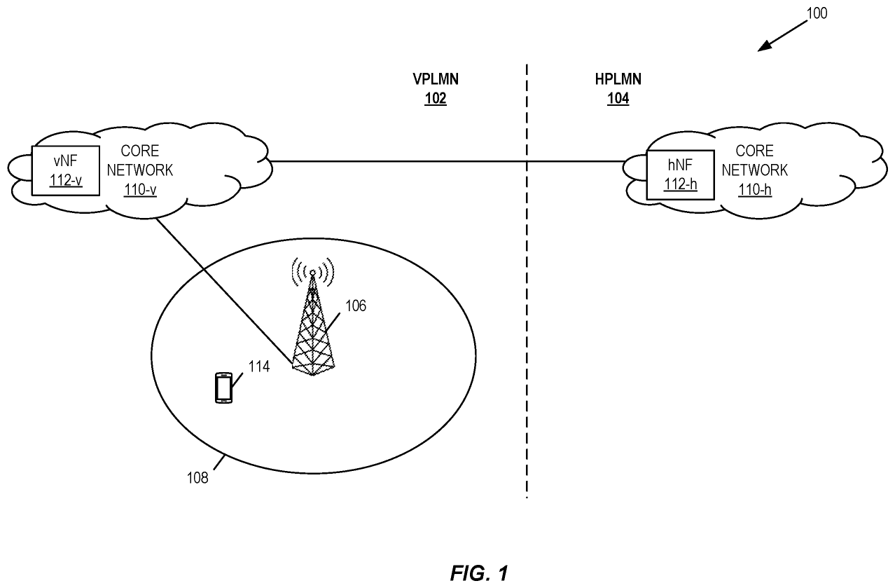

FIG. 1 illustrates one example of a cellular communications system 100 in which embodiments of the present disclosure may be implemented. In the embodiments described herein, the cellular communications system 100 is for a roaming scenario in which there is a VPLMN 102 and a HPLMN 104. In one embodiment, the cellular communications system 100 is a 5G system (5GS); however, the present disclosure is not limited thereto. In this example, the VPLMN 102 includes a Radio Access Network (RAN) include a RAN node 106 (e.g., a base station), which in the 5GS is a gNB, controlling a corresponding cell 108. The VPLMN 102 also includes a core network 110-v, which in the 5GS is the 5GC. The core network 110-v includes a number of core network nodes, which in this example are NFs 112-v. Note that the core network 110-v is also referred to herein as a “visited core network 110-v” to distinguish it from a core network 110-h of the HPLMN 104. Likewise, the NFs 112-v are also referred to herein as “visited NFs 112-v” or “vNFs 112-v” to distinguish them from NFs 112-h of the HPLMN 104. The RAN node 106 is connected to the visited core network 110-v.

The HPLMN 104 also includes the core network 110-h, which includes the NFS 112-h. Note that the core network 110-h of the HPLMN 104 is also referred to herein as a “home core network 110-h” to distinguish it from the visited core network 110-v of the VPLMN 102. Likewise, the NFs 112-h are also referred to herein as “home NFs 112-h” or “hNFs 112-h” to distinguish them from the vNFs 112-v of the VPLMN 102.

In the embodiments described herein, a wireless communication device 114 is in a roaming scenario in which the HPLMN 104 is the home network of the wireless communication device 114 but the wireless communication device 114 registers to the VPLMN 102. Note that while only one VPLMN 102 is illustrated in FIG. 1, as described herein, the wireless communication device 114 may be registered with two (or more) VPLMNs 102 at the same time. In the following description, the wireless communication device 114 is oftentimes a UE and as such sometimes referred to herein as a UE 114, but the present disclosure is not limited thereto.

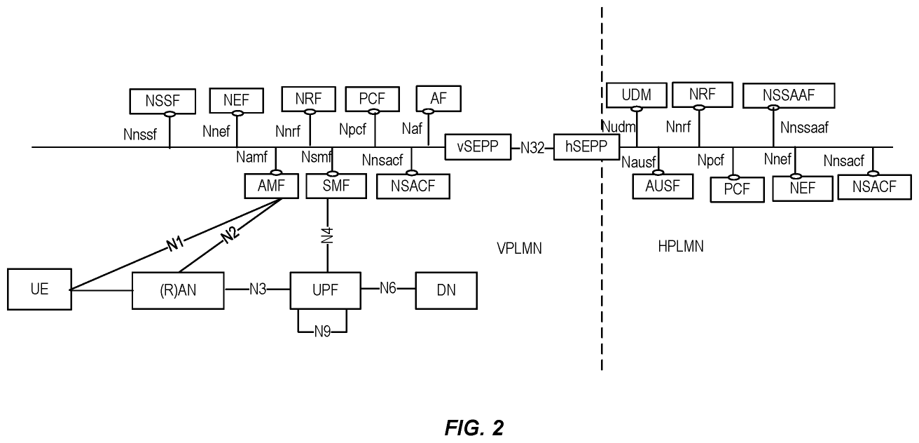

FIG. 2 illustrates a wireless communication system represented as an example 5G network roaming architecture composed of core Network Functions (NFs), where interaction between any two NFs is represented by a point-to-point reference point/interface. FIG. 2 can be viewed as one particular implementation of the system 100 of FIG. 1. While the details of the various nodes illustrated in FIG. 2 are known to those of skill in the art, while not essential for understanding the present disclosure, the interested reader is directed to 3GPP 23.501 V17.1.1.

Now, the description turns to a description of some example embodiments of the present disclosure.

### Option 1: UE Registration Based Option

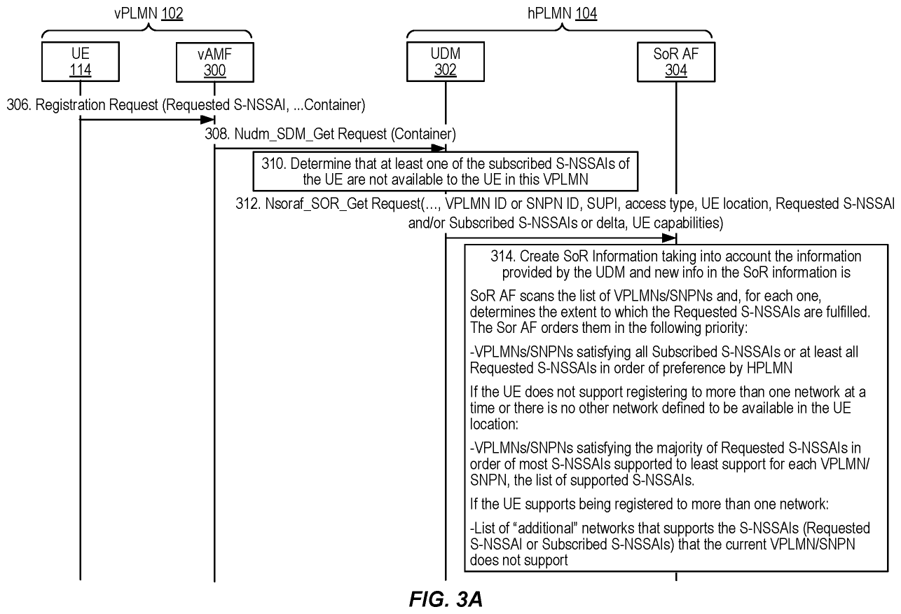

In this option, the UE 114 includes, at 5GC Registration, a transparent container intended for UDM 302. In one embodiment, visited AMF (vAMF) 300 in the visited domain (i.e., the VPLMN 102) transparently includes this container to the UDM 302 as shown in procedure of FIGS. 3A and 3B. This procedure involves the UE 114, the vAMF 300, the UDM 302, and a Steering of Roaming (SoR) Application Function (AF) 304. The steps of the procedure of FIGS. 3A and 3B are as follows:
Step 306: While roaming, the UE 114 includes a new transparent container in a 5G Registration Request when the UE 114 performs Initial Registration or when the UE 114 wants the HPLMN 104 to be aware of UE changes, e.g. UE capability changes or UE requests new network slices. This new container is an indication that the UE 114 wants the UDM 302 to provide the UE 114 with some information. The container includes an indication of the requested information and includes UE information that is pertinent to the request.
   New Information: In one embodiment, the UE 114 may send a protected container (transparent for the vAMF 300, i.e. container is protected with home network security information) that includes information relevant for the UDM 302, e.g. UE capabilities, UE location, Requested NSSAI. The UE capabilities may include, e.g., a capability to receive and handle enhanced SoR information (e.g., SoR information that includes a prioritized list of VPLMNs (or SNPNs) and either or both of: (a) information that indicates network slices (of the HPLMN) that are supported by the VPLMN (or SNPN), which may be for example S-NSSAI(s), and (b) information that indicates an applicability of the enhanced SoR information, e.g., a time and/or geographic location in which the enhanced SoR information is applicable). The UE capabilities may additionally or alternatively include a capability to provide additional information (e.g., UE location and/or requested NSSAI) to the network.
   Note that the new information may alternatively be sent by the UE 114 to the network in response to a request. For example, initial SOR information may be provided to the UE 114, e.g., in the conventional manner, together with a request for the new information, and the UE 114 may then send the UE new information to the network, e.g., in an ACK to the initial SoR information. The new information may then be used to provide enhanced SoR information to the UE 114, as described below.
Step 308: The vAMF 300 forwards the container transparently from the UE 114 to the UDM 302 in a Nudm_SDM_Get Request.
Step 310: The UDM 302 determines that at least one of the subscribed S-NSSAIs of the UE 114 are not available to the UE 114 in this VPLMN 102. In one embodiment, the UDM 302 uses UE capabilities of the UE 114 (e.g., included in the container provided in the Nudm_SDM_Get Request) to check that the UE 114 supports the ability to handle enhanced SoR information. If the UE 114 supports the ability to handle enhanced SoR information (as indicated by the UE capabilities or the UE does not provide any UE capabilities), the UDM 302 indicates that as further UE capabilities to a SOR AF 304 in step 312.
Step 312: The UDM 302 sends a Nsoraf_SoR_Get request to the SOR AF 304. The Nxoraf_SoR_Get request includes: (a) VPLMN ID (or SNPN ID, i.e. PLMN ID+NID), (b) Subscription Permanent Identifier (SUPI) of the UE 114, (c) access type (see 3GPP TS 29.571, (d) UE location, (e) Requested NSSAI or S-NSSAIs not supported by current VPLMN 302 or list of PLMNs/SNPNs supporting all Subscribed S-NSSAIs or the S-NSSAIs that are not supported by current VPLMN 302, (f) UE capability to register to more than one network, (g) UE capability to receive enhanced SoR information, or (h) a combination of any two or more of (a)-(g). Basically, all of the information in the received container by the UDM 302 is sent transparently to the SOR AF 304.
Step 314: The SOR AF 304 creates SoR information taking into account the information provided by the UDM 302 and new information in SoR info is provided. The SoR info including this new information is referred to herein as “enhanced SoR info” or “enhanced SoR information”. This new information includes a list of VPLMNs, which is preferably prioritized based on network slices supported by and/or requested by the UE 114. In one embodiment, the new information included in the enhanced SoR info includes, in addition to the (prioritized) list of VPLMNs: (a) for each VPLMN in the list, information (e.g., S-NSSAI(s)) that indicates one or more network slices (for the HPLMN) that are supported by the VPLMN and/or (b) information that indicates an applicability (also referred to herein as “validity”) for the enhanced SoR information (e.g., a time and/or geographic area in which the enhanced SoR information is applicable). More specifically, in one embodiment, in order to generate the prioritized list of VPLMNs, the SOR AF 304 scans the list of VPLMNs/SNPNs included in the Nsoraf_SoR_Get Request and, for each one, determines the extent to which the Requested S-NSSAI(s) are fulfilled. The SOR AF 304 orders (i.e., prioritizes) the VPLMNs/SNPNs in the following priority:
   VPLMNs/SNPNs supporting all Subscribed S-NSSAIs or at least all Requested S-NSSAIs in order of preference by the HPLMN 104.
   If the UE 114 does not support registering in more than one network at the same time or there is no other network defined to be available in the UE location:
      VPLMNs/SNPNs supporting the majority of the Requested S-NSSAIs in order of most S-NSSAIs supported to least supported. For each VPLMN/SNPN, the list may also include a list of supported S-NSSAIS.
   If the UE 114 does support being registered with more than one network at the same time:
      List of “additional” networks that support the S-NSSAIs (Requested S-NSSAIs or Subscribed S-NSSAIs) that the current VPLMN/SNPN does not support.
Step 316: The SOR AF 304 sends a Nsoraf_SoR_Get response to the UDM 302 including the enhanced SoR info. The enhanced SoR info includes the (e.g., prioritized) list of VPLMNs from step 314. In one embodiment, the enhanced SoR info for the UE 114 may further include, e.g. dependent on UE capabilities, supported S-NSSAIs per network (e.g., per VPLMN or per SNPN) and optionally some validity (also referred to herein as applicability), e.g. area or time, as described above.
Step 318: The HPLMN 104 (e.g., UDM 302) (or CH) sends the enhanced SoR info to the vAMF 300 within the Access and Mobility Subscription data, i.e. vAMF 300 is transparent to the content.
Step 320: The vAMF 300 forwards the enhanced SoR info to the UE 114 within the Registration Accept as per current specifications. The UE 114 may store the enhanced SoR info.
Step 322: The UE 114 uses the enhanced SoR info and Allowed NSSAI, e.g. if UE supports registering to additional network and the Allowed NSSAI didn't include all slices of Requested NSSAI then the UE 114 scans for VPLMN/SNPN supporting the S-NSSAIs not in Allowed NSSAI and selects and registers accordingly.

Normal procedure continues after that. The UE 114 can register in a different VPLMN for the S-NSSAI that the UE 114 wants to use, e.g. keeping the registration to the current VPLMN if the UE 114 and the HPLMN 104 support the UE 114 being registered via two VPLMNs.

### Option 2: UPU Option

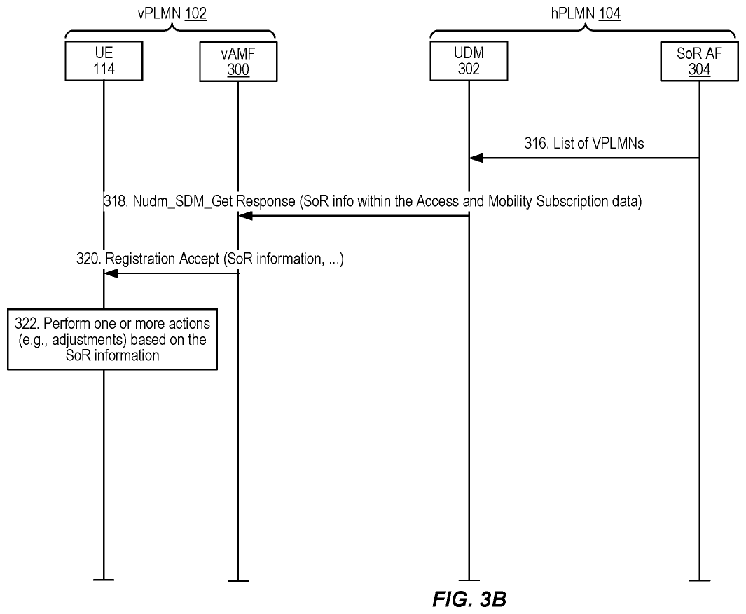

Option 2 is another variant where the UE Configuration Update (UPU) Procedure is used to provide the UE 114 with the required information. Before doing that, in one embodiment, the UDM 302 will request the UE capabilities to ensure that the UE 114 can actually receive and process this new information. Alternatively, the UDM 302 can be configured with the UE capabilities. FIGS. 4A and 4B illustrate one example embodiment of the solution for Option 2. The steps of the procedure of FIGS. 4A and 4B are as follows:
Step 400: The UE 114 performs a regular Registration. During or after (e.g., directly after) that procedure, the UDM 302 notifies the vAMF 300 to trigger the vAMF 300 to send to the UE 114 a configuration update (e.g., UE Parameter Update (UPU) via UDM Control Plane Procedure).
Step 402: The UDM 302 determines that a subset (e.g., at least one) of the UE subscribed NSSAI are not supported by the current VPLMN 102, The UDM 302 (if not configured with the UE capabilities) fetches the UE capabilities of the UE 114 to see if the UE 114 can provide additional informational (e.g., enhanced SoR info) to the UE 114.
Step 404: The UDM 302 sends, to the vAMF 300, an Nudm SDM Notification to trigger the UE 114 to return its capabilities. The notification includes a downlink (DL) Non-Access Stratum (NAS) message that requests the UE 114 to returns its capabilities and an identification (ID) of the stored information (i.e., the SoR information stored in the UE 114 about the VPLMN (or SNPN) prioritized list). This ID can be an ID that SOR AF 304 provides to the UE 114 in step 416/418/420. As an alternative to this ID, the SOR AF 304 may store some indication of the information each UE has in case the SOR AF 304 wants to avoid sending information when the UE has up to date information. In case we want the UE 114 to indicate what the UE 114 has stored such that the HPLMN 104 then knows whether it needs to update the UE 114 or not, this identification of the stored information can also be always sent by the UE 114 to the network. In other words, when the UE 114 provides the identification of the stored information, the HPLMN 104 may use the identification of the stored information to determine what information is stored in the UE 114 and to update the UE 114 based on the identification of the stored information. The identification of the stored information can be, e.g., an id that the network previously sent to the UE 114 together with last updated information or a hash of the stored information or some validity information of the stored information, e.g. area and/or time when inform is valid.
Step 406: The vAMF 300 sends a DL NAS TRANSPORT message to the UE 114, where this DL NAS TRANSPORT message includes an indication that the UDM 304 requests the UE capabilities of the UE 114 to handle enhanced SoR information (e.g., a list of VPLMNs and optional supported network slices and/or applicability/validity info, as described herein).
Step 408: The UE 114 returns its capabilities and optionally an identification of the stored information in an NAS UL TRANSPORT message to the vAMF 300.
Step 410: The vAMF 300 sends, to the UDM 302, an Nudm_Service_Info UPU (Container) including the transparent container indicating that the UE 114 has the capabilities to receive enhanced SoR information and optionally an identification of the stored information.
Step 412: The UDM 302 decides to fetch the enhanced SoR information to send to the UE 114. This decision may include determining whether the UE 114 has the capability to handle enhanced SoR data. In this example embodiment, the UDM 302 initiates Nsoraf_SoR_Get request to the SOR AF 304 and includes at least some of the following information: VPLMN ID (or SNPN ID, i.e. PLMN ID+NID), SUPI of the UE, access type (see 3GPP TS 29.571), UE location, Requested NSSAI or S-NSSAIs not supported by current VPLMN or list of PLMNs/SNPNs supporting all Subscribed S-NSSAIs or the S-NSSAIs that are not supported by current VPLMN, and UE capability to register to more than one network, in this example. The UDM 302 can also include the content of the container transparently to the SOR AF 304 (without modifying it).
Step 414: The SOR AF 304 creates enhanced SoR information taking into account the information provided by the UDM and new information in SOR info, as described above with respect to step 314 of the procedure illustrated in FIGS. 3A and 3B.
Step 416: The SOR AF 304 sends to the UDM 302 the requested SoR info, which this example includes the list of VPLMNs and optionally the supported network slices for each VPLMN in the list and/or applicability/validity info, as described above.
Step 418: The UDM 302 sends, to the vAMF 300, a Nudm_Notify and includes the enhanced SoR information.
Step 420: The vAMF 300 sends a DL NAS TRANSPORT message including the enhanced SoR information to the UE 114. Optionally, an ID of the enhanced SoR information may be included in the message. The enhanced SoR information may, for example, be provided as Operator Controlled PLMN Selector with Access Technology and/or preferred PLMN/access technology combinations (e.g., see 3GPP 23.122). The UE 114 may store the enhanced SoR information.
Step 422: The UE 114 returns UPU ACK in an NAS UL TRANSPORT message to the vAMF 300.
Step 424: The vAMF 300 sends to the UDM 302 an Nudm_Service_Info UPU ( ) to acknowledge UE reception of the enhanced SoR info including the VPLMN List.

The normal procedure continues after that. The UE 114 can register in a different VPLMN for the S-NSSAI that the UE 114 wants to use.

### Option 3: URSP (UE Policy) Option

In this option, PCF is notified to enable new UE Policies, e.g. URSP to be downloaded in the UE 114 and that includes information for networks (PLMNs or SNPNs) to be used in association with the configured S-NSSAIs.

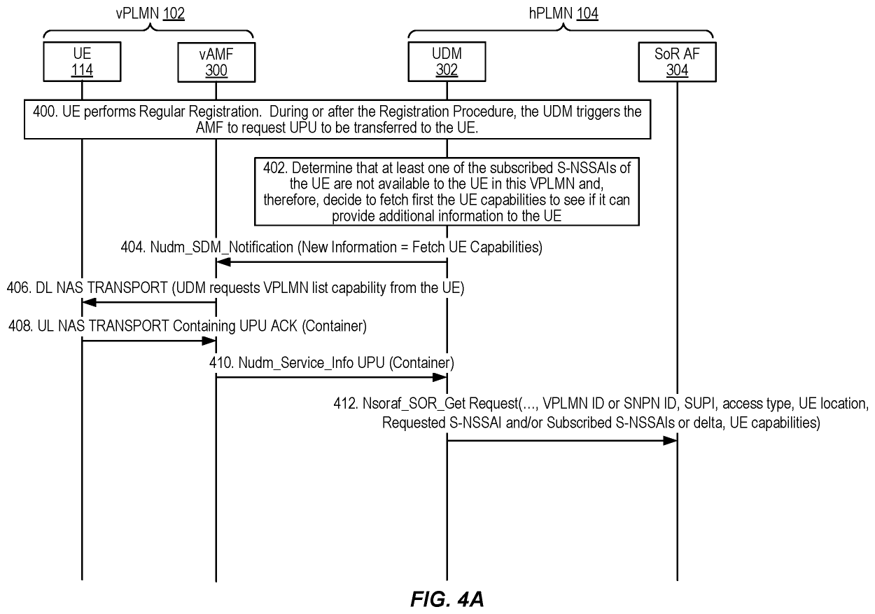

FIG. 5 illustrates a procedure in accordance with one example embodiment of Option 3. This procedure additionally involves vPCF 500-v and hPCF 500-h. The steps of the procedure of FIG. 5 are as follows:
Step 502: While roaming (or also when not roaming), the UE 114 includes a new transparent container in a 5G Registration Request or provides additional information in an “extended” UE Policy Container. The container includes information relevant for the hPCF 500-h to create suitable updated policy information for the UE 114, e.g. UE capabilities, UE location.
   New Information: The UE 114 may send a protected container (transparent for the vAMF 300) that includes info relevant for the hPCF 500-h, e.g. UE capabilities, UE location.
Step 504: The vAMF 300 forwards the container transparently from the UE 114 to the vPCF 500-v, and the vPCF 500-v forwards it to the hPCF 500-h as per current procedures in Npcf_UEPolicyControl_Create or similar if a new type of UE policy is to be used.
Step 506: Steps 4-5 in FIG. 4.16.11-1 of 3GPP TS 23.502 are performed.
Step 508: The hPCF 500-h uses the extended UE Policy Container to derive suitable UE policies e.g.
   UE capabilities whether the UE supports the extended UE policies and whether the UE supports being registered in more than one network at a time.
   UE location (e.g., country, region, or geographical area) can be used to derive policies suitable for the area the UE is located, e.g., including only policies for networks which home network has agreements.
Step 510: Steps 7-10 in FIG. 4.16.11-1 of TS 23.502 are performed. Note that the UE policies are provided to the UE 114 as part of step 510.
Step 512: The UE 114 uses the UE Policies as to decide which network to use for which application, service.
In one embodiment, the extended UE policies are implemented an extended URSP. In one embodiment, the URSP are extended with the network id to which each rule is applicable to as seen in Table 1 below. The network id can be a PLMN ID or an SNPN ID and it can be one or more networks listed in priority order (or separate rules can be created in such case).

TABLE 1
Extended Policy Rules

| Information | | | PCF permitted to | |
|---|---|---|---|---|
| Name | Description | Category | modify in URSP | Scope |
| Route | Determines the order in | Mandatory | Yes | UE context |
| Selection | which the Route Selection | | | |
| Descriptor | Descriptors are to be | | | |
| Precedence | applied. | | | |
| Route | This part defines the route | Mandatory | | |
| Selection | selection components. | | | |
| Components | | | | |
| SSC Mode | One single value of SSC | Optional | Yes | UE context |
| Selection | mode. | | | |
| PLMN | The PLMN ID of SNPN to | Optional | Yes | UE context |
| Selection | use. | | | |
| Network | Either a single value or a | Optional | Yes | UE context |
| Slice | list of values of S-NSSAI(s). | | | |
| Selection | | | | |
| DNN | Either a single value or a | Optional | Yes | UE context |
| Selection | list of values of DNN(s). | | | |
| PDU Session | One single value of PDU | Optional | Yes | UE context |
| Type | Session Type. | | | |
| Selection | | | | |
| Non- | Indicates if the traffic of the | Optional | Yes | UE context |
| Seamless | matching application is to | | | |
| Offload | be offloaded to non-3GPP | | | |
| Indication | access outside of a PDU | | | |
| | Session. | | | |
| Access Type | Indicates the preferred | Optional | Yes | UE context |
| Preference | Access Type (3GPP or non- | | | |
| | 3GPP or Multi-Access) when | | | |
| | the UE establishes a PDU | | | |
| | Session for the matching | | | |
| | application. | | | |
| Route | This part defines the Route | Optional | Yes | UE context |
| Selection | Validation Criteria | | | |
| Validation | components | | | |
| Criteria | | | | |
| Time | The time window when the | Optional | Yes | UE context |
| Window | matching traffic is allowed. | | | |
| | The RSD is not considered | | | |
| | to be valid if the current | | | |
| | time is not in the time | | | |
| | window. | | | |
| Location | The UE location where the | Optional | Yes | UE context |
| Criteria | matching traffic is allowed. | | | |
| | The RSD rule is not | | | |
| | considered to be valid if the | | | |
| | UE location does not match | | | |
| | the location criteria. | | | |

Normal procedure continues after that. The UE can register in a different VPLMN or SNPN for the S-NSSAI that UE 114 wants to use.

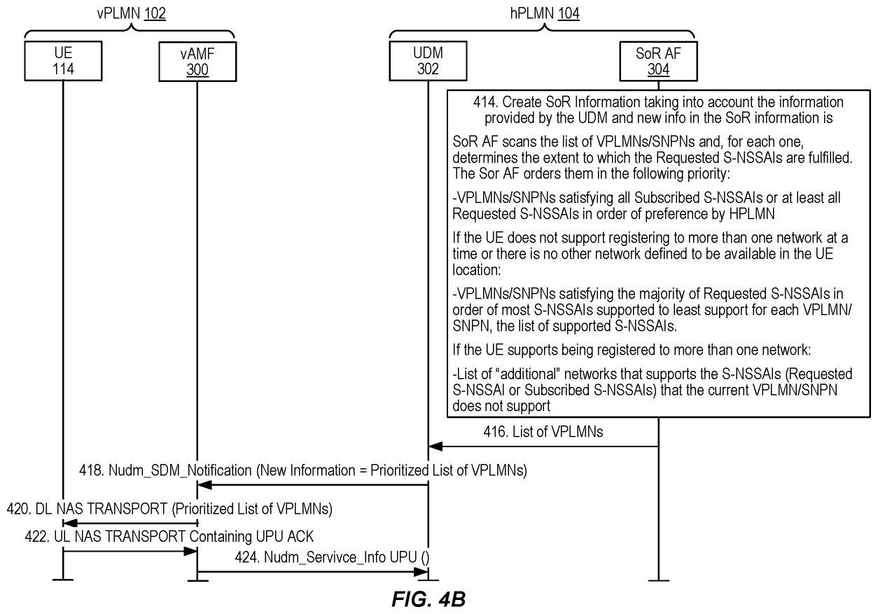

FIG. 6 is a schematic block diagram of a network node 600 according to some embodiments of the present disclosure. Optional features are represented by dashed boxes. The network node 600 may be, for example, a core network node that implements a NF (e.g., vAMF 300, UDM 302, SOR AF 304, vPCF 500-v, hPCF 500-h, or the like) or a network node that implements all or part of the functionality of an NF (e.g., all or part of the functionality of the vAMF 300, UDM 302, SOR AF 304, vPCF 500-v, hPCF 500-h, or the like, as described herein). As illustrated, the network node 600 includes a one or more processors 604 (e.g., Central Processing Units (CPUs), Application Specific Integrated Circuits (ASICs), Field Programmable Gate Arrays (FPGAS), and/or the like), memory 606, and a network interface 608. The one or more processors 604 are also referred to herein as processing circuitry. The one or more processors 604 operate to provide one or more functions of the network node 600 as described herein (e.g., one or more functions of the AMF, the SMF, or the NSACF described herein). In some embodiments, the function(s) are implemented in software that is stored, e.g., in the memory 606 and executed by the one or more processors 604.

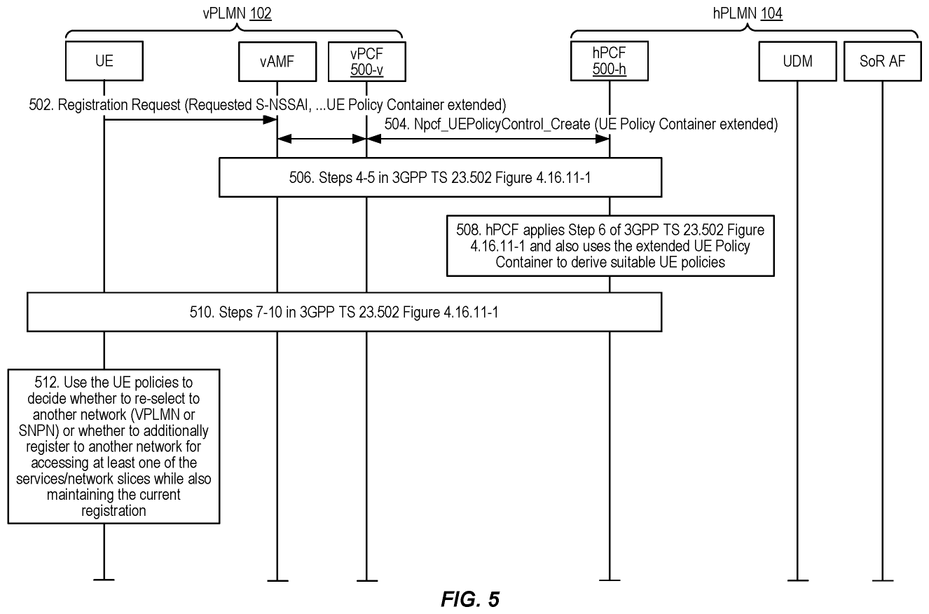

FIG. 7 is a schematic block diagram that illustrates a virtualized embodiment of the network node 600 according to some embodiments of the present disclosure. Again, optional features are represented by dashed boxes. As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, the network node 600 includes one or more processing nodes 700 coupled to or included as part of a network(s) 702. Each processing node 700 includes one or more processors 704 (e.g., CPUs, ASICs, FPGAS, and/or the like), memory 706, and a network interface 708. In this example, functions 710 of the network node 600 described herein (e.g., all or part of the functionality of the vAMF 300, UDM 302, SOR AF 304, vPCF 500-v, hPCF 500-h, or the like, as described herein) are implemented at the one or more processing nodes 700 or distributed across the two or more processing nodes 700 in any desired manner. In some particular embodiments, some or all of the functions 710 of the network node 600 described herein are implemented as virtual components executed by one or more virtual machines implemented in a virtual environment(s) hosted by the processing node(s) 700.

In some embodiments, a computer program including instructions which, when executed by at least one processor, causes the at least one processor to carry out the functionality of the network node 600 or a node (e.g., a processing node 700) implementing one or more of the functions 710 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

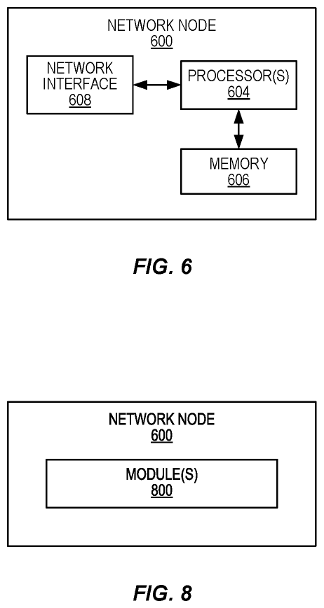

FIG. 8 is a schematic block diagram of the network node 600 according to some other embodiments of the present disclosure. The network node 600 includes one or more modules 800, each of which is implemented in software. The module(s) 800 provide the functionality of the network node 600 described herein. This discussion is equally applicable to the processing node 700 of FIG. 7 where the modules 800 may be implemented at one of the processing nodes 700 or distributed across multiple processing nodes 700.

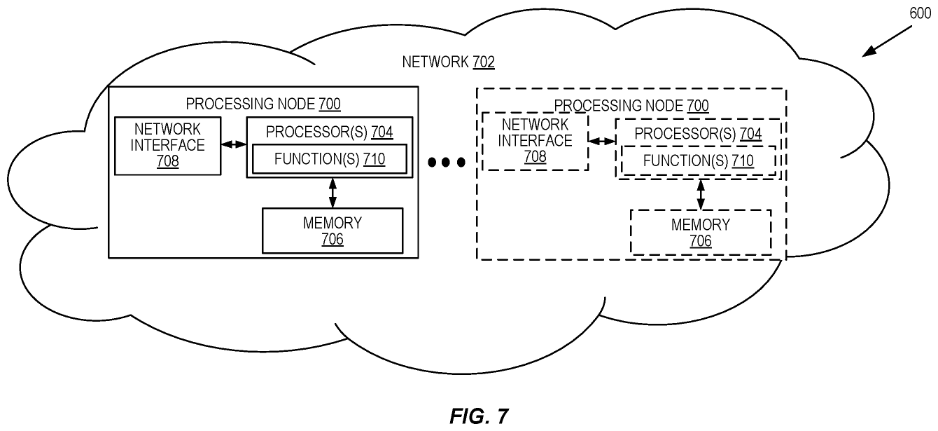

FIG. 9 is a schematic block diagram of a wireless communication device 900 (e.g., wireless communication device or UE 114) according to some embodiments of the present disclosure. As illustrated, the wireless communication device 900 includes one or more processors 902 (e.g., CPUs, ASICS, FPGAS, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the wireless communication device 900 (e.g., the functionality of the wireless communication device 114 or UE 114 described above) may be fully or partially implemented in software that is, e.g., stored in the memory 904 and executed by the processor(s) 902. Note that the wireless communication device 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In some embodiments, a computer program including instructions which, when executed by at least one processor, causes the at least one processor to carry out the functionality of the wireless communication device 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

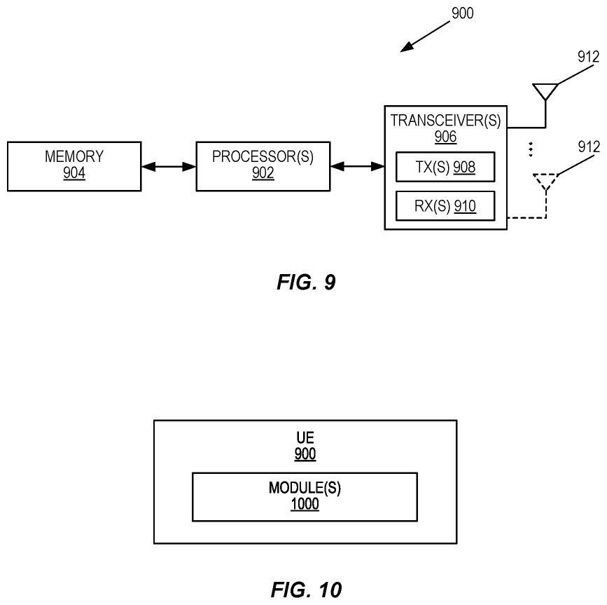

FIG. 10 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed in a cellular communications system (100), the method comprising:
at a first Network Function, NF, (302) in a home network (104) of a wireless communication device (114) in a roaming scenario:
   obtaining (312, 316; 412, 416) Steering of Roaming, SoR, information for the wireless communication device (114), the SoR information comprising a prioritized list of visited (or non-public) networks for the wireless communication device (114), where visited (or non-public) networks comprised in the prioritized list are prioritized based on one or more network slices requested by the wireless communication device (114) and/or one or more network slices to which the wireless communication device (114) is subscribed;
   sending (318; 418), to a second NF (300) in a visited (or non-public) network of the wireless communication device (114), a message comprising the SoR information;
at the second NF (300):
   receiving (318; 418) the message comprising the SoR information; and
   sending (320; 420) a message to the wireless communication device (114) comprising the SoR information; and
at the wireless communication device (114):
   receiving (320; 420) the message from the second NF (300); and
   performing (322; 422) one or more actions based on the SoR information.

Embodiment 2: The method of embodiment 1 wherein the SOR information further comprises, for each visited (or non-public) network comprised in the prioritized list, information that indicates one or more network slices supported by the visited (or non-public) network.

Embodiment 3: The method of embodiment 1 wherein the SOR information further comprises, for each visited (or non-public) network comprised in the prioritized list, information that indicates one or more network slices of a home network of the wireless communication device (114) that are supported by the visited (or non-public) network.

Embodiment 4: The method of any of embodiments 1 to 3 wherein the SOR information further comprises validity information that indicates one or more conditions under which the SoR information is valid.

Embodiment 5: The method of any of embodiments 1 to 3 wherein the SOR information further comprises validity information that indicates a time during which the SoR information is valid.

Embodiment 6: The method of any of embodiments 1 to 3 wherein the SOR information further comprises validity information that indicates a geographic area in which the SoR information is valid.

Embodiment 7: The method of any of embodiments 1 to 6 further comprising, at the wireless communication device (114), storing (320; 420) the message received from the second NF (300).

Embodiment 8: The method of any of embodiments 1 to 7 wherein:
at the first NF (302), obtaining (312, 316; 412, 416) the SOR information comprises:
   sending (312; 412), to a third NF (304) in the home network (304) of the wireless communication device (114), a request comprising:
      (a) an identifier of the visited network (102) (or non-public network) of the wireless communication device (114),
      (b) a geographic location of the wireless communication device (114),
      (c) information that indicates the one or more network slices requested by the wireless communication device (114),
      (d) information that indicates the one or more network slices to which the wireless communication device (114) is subscribed,
      (e) information that indicates the one or more network slices requested by the wireless communication device (114) that are not supported by the visited network (102) (or non-public network) of the wireless communication device (114),
      (f) information that indicates the one or more network slices to which the wireless communication device (114) is subscribed that are not supported by the visited network (102) (or non-public network) of the wireless communication device (114),
      (g) information that indicates a capability of the wireless communication device (114) for registration to more than one network,
      (h) information that indicates one or more capabilities of the wireless communication devices (114) related to its ability to handle enhanced SoR information,
      (i) information that indicates one or more capabilities of the wireless communication device (114) to provide additional information to the network, the additional information including information that indicates one or more network slices requested by the wireless communication device (114), or
      (j) a combination of any two or more of (a)-(i); and
   receiving (316; 416), from the third NF (304), a response comprising the SoR information.

Embodiment 9: The method of embodiment 8 further comprising, at the third NF (304): receiving (312; 412) the request from the first NF (302); and, responsive to receiving (312; 412) the request from the first NF (302), generating (314; 414) SoR information comprising the prioritized list of visited (or non-public) networks.

Embodiment 10: The method of any of embodiments 1 to 9 wherein the prioritized list of visited (or non-public) networks is prioritized based on whether the visited (or non-public) networks support all of the subscribed network slices and/or all of the requested network slices.

Embodiment 11: The method of embodiment 10 wherein the prioritized list of visited (or non-public) networks is further prioritized based on preference of the home network.

Embodiment 12: The method of any of embodiments 1 to 11 wherein the prioritized list of visited (or non-public) networks is prioritized based on priorities assigned to the network slices.

Embodiment 13: The method of any of embodiments 1 to 9 wherein the prioritized list of visited (or non-public) networks is prioritized such that visited (or non-public) networks supports all of the one or more network slices to which the wireless communication device (114) is subscribed or at least all of the one or more network slices requested by the wireless communication device (114) are prioritized in order of preference of the home network.

Embodiment 14: The method of embodiment 13 wherein: the wireless communication device (114) does not support registration in more than one network at the same time or there is no further network available to the wireless communication device (114) that supports all of the one or more network slices to which the wireless communication device (114) is subscribed or at least all of the one or more network slices requested by the wireless communication device (114); and the prioritized list of visited (or non-public) networks next prioritizes visited (or non-public) networks supports at least a (e.g., predefined or configured) threshold amount of the one or more network slices to which the wireless communication device (114) is subscribed or the one or more network slices requested by the wireless communication device (114).

Embodiment 15: The method of embodiment 13 wherein: the wireless communication device (114) supports registration in more than one network at the same time; and the prioritized list of visited (or non-public) networks next prioritizes visited (or non-public) networks that support at least one network slice requested by or subscribed to by the wireless communication device (114) that is not supported by the visited (or non-public) network of the wireless communication device (114).

Embodiment 16: The method of any of embodiments 1 to 15 further comprising, at the first NF (302), determining (310; 402) that at least one subscribed network slice of the wireless communication device (114) is not available to the wireless communication device (114) in the visited network (102) (or non-public network) in which the wireless communication device (114) is currently located.

Embodiment 17: The method of any of embodiments 1 to 16 further comprising, at the first NF (302), receiving (308), via the second network function (300) in the visited network (102) (or non-public network), a container comprising information that indicates: (i) the one or more network slices requested by the wireless communication device (114), (ii) a capability of the wireless communication device (114) related to handling of enhanced SoR information, (iii) a location of the wireless communication device (114), or (iv) a combination of any two or more of (i)-(iii).

Embodiment 18: The method of embodiment 17 wherein the container is received in association a registration procedure in which the wireless communication device (114) requests registration with the visited (or non-public) network in which the wireless communication device (114) is located.

Embodiment 19: A network node adapted to perform the functions of the first NF, the second NF, or the third NF of embodiments 1 to 18.

Embodiment 20: A method performed by a first Network Function, NF, (302) in a home network (104) of a wireless communication device (114) in a roaming scenario, the method comprising: obtaining (312, 316; 412, 416) Steering of Roaming, SoR, information for the wireless communication device (114), the SOR information comprising a prioritized list of visited (or non-public) networks that are prioritized based on one or more network slices requested by the wireless communication device (114) and/or one or more network slices to which the wireless communication device (114) is subscribed; and sending (318; 418), towards the wireless communication device (114), a message comprising the SoR information.

Embodiment 21: The method of embodiment 20 wherein the SoR information further comprises, for each visited (or non-public) network comprised in the prioritized list, information that indicates one or more network slices supported by the visited (or non-public) network.

Embodiment 22: The method of embodiment 20 wherein the SOR information further comprises, for each visited (or non-public) network comprised in the prioritized list, information that indicates one or more network slices of a home network of the wireless communication device (114) that are supported by the visited (or non-public) network.

Embodiment 23: The method of any of embodiments 20 to 22 wherein the SoR information further comprises validity information that indicates one or more conditions under which the SOR information is valid.

Embodiment 24: The method of any of embodiments 20 to 22 wherein the SoR information further comprises validity information that indicates a time during which the SoR information is valid.

Embodiment 25: The method of any of embodiments 20 to 22 wherein the SoR information further comprises validity information that indicates a geographic area in which the SoR information is valid.

Embodiment 26: The method of any of embodiments 20 to 25 wherein obtaining (312, 316; 412, 416) the SoR information comprises:
sending (312; 412), to a second NF (304) in the home network (304) of the wireless communication device (114), a request comprising:
   (a) an identifier of a visited network (102) (or non-public network) in which the wireless communication device (114) is currently located,
   (b) a geographic location of the wireless communication device (114),
   (c) information that indicates the one or more network slices requested by the wireless communication device (114),
   (d) information that indicates the one or more network slices to which the wireless communication device (114) is subscribed,
   (e) information that indicates the one or more network slices requested by the wireless communication device (114) that are not supported by the visited network (102) (or non-public network) in which the wireless communication device (114) is currently located,
   (f) information that indicates the one or more network slices to which the wireless communication device (114) is subscribed that are not supported by the visited network (102) (or non-public network) in which the wireless communication device (114) is currently located,
   (g) information that indicates a capability of the wireless communication device (114) for registration to more than one network,
   (h) information that indicates one or more capabilities of the wireless communication devices (114) related to its ability to handle enhanced SoR information,
   (i) 1information that indicates one or more capabilities of the wireless communication device (114) to provide additional information to the network, the additional information including information that indicates one or more network slices requested by the wireless communication device (114), or
   (j) a combination of any two or more of (a)-(i); and
receiving (316; 416), from the second NF (304), a response comprising the SoR information.

Embodiment 27: The method of embodiment 20 or 26 further comprising determining (310; 402) that at least one subscribed network slice of the wireless communication device (114) is not available to the wireless communication device (114) in the visited network (102) (or non-public network) in which the wireless communication device (114) is currently located.

Embodiment 28: The method of any of embodiments 20 to 27 further comprising receiving (308), via a third network function (300) in the visited network (102) (or non-public network) in which the wireless communication device (114) is currently located, a container comprising information that indicates: (i) the one or more network slices requested by the wireless communication device (114), (ii) a capability of the wireless communication device (114) related to handling of enhanced SoR information, (iii) a location of the wireless communication device (114), or (iv) a combination of any two or more of (i)-(iii).

Embodiment 29: The method of embodiment 28 wherein the container is received in association a registration procedure in which the wireless communication device (114) requests registration with the visited (or non-public) network in which the wireless communication device (114) is located.

Embodiment 30: The method of any of embodiments 20 to 27 wherein obtaining (412, 416) the SoR information and sending (418), towards the wireless communication device (114), the message comprising the SOR information are performed subsequent to registration of the wireless communication device (114) with the visited network (102) (or non-public network) in which the wireless communication device (114) is currently located.

Embodiment 31: The method of embodiment 30 further comprising determining or obtaining (404, 410) information about a capability of the wireless communication device (114) to handle enhanced SoR information.

Embodiment 32: The method of any of embodiments 20 to 31 further comprising determining (310; 412) whether the wireless communication device (114) is capable of handling enhanced SoR information.

Embodiment 33: A method performed by a first Network Function, NF, (304) associated to a home network (104) of a wireless communication device (114) in a roaming scenario, the method comprising:
receiving (312; 412), from a second NF (302) in the home network (304) of the wireless communication device (114), a request comprising:
   (a) an identifier of a visited network (102) (or non-public network) in which a wireless communication device (114) is currently located,
   (b) a geographic location of the wireless communication device (114),
   (c) information that indicates one or more network slices requested by the wireless communication device (114),
   (d) information that indicates one or more network slices to which the wireless communication device (114) is subscribed,
   (e) information that indicates the one or more network slices requested by the wireless communication device (114) that are not supported by a visited network (102) (or non-public network) of the wireless communication device (114),
   (f) information that indicates the one or more network slices to which the wireless communication device (114) is subscribed that are not supported by the visited network (102) (or non-public network) of the wireless communication device (114),
   (g) information that indicates a capability of the wireless communication device (114) for registration to more than one network,
   (h) information that indicates one or more capabilities of the wireless communication devices (114) related to its ability to handle enhanced Steering of Roaming, SoR, information,
   (i) information that indicates one or more capabilities of the wireless communication device (114) to provide additional information to the network, the additional information including information that indicates one or more network slices requested by the wireless communication device (114), or
   (j) a combination of any two or more of (a)-(i); and
generating (314; 414) SoR information for the wireless communication device (112), the SoR information comprising a prioritized list of visited (or non-public) networks for the wireless communication device (114), where visited (or non-public) networks comprised in the prioritized list are prioritized based on the one or more network slices requested by the wireless communication device (114) and/or the one or more network slices to which the wireless communication device (114) is subscribed; and
sending (316; 416), to the second NF (302), a response comprising the prioritized list of visited (or non-public) networks.

Embodiment 34: The method of embodiment 33 wherein the SOR information further comprises, for each visited (or non-public) network comprised in the prioritized list, information that indicates one or more network slices supported by the visited (or non-public) network.

Embodiment 35: The method of embodiment 33 wherein the SOR information further comprises, for each visited (or non-public) network comprised in the prioritized list, information that indicates one or more network slices of a home network of the wireless communication device (114) that are supported by the visited (or non-public) network.

Embodiment 36: The method of any of embodiments 33 to 35 wherein the SoR information further comprises validity information that indicates one or more conditions under which the SOR information is valid.

Embodiment 37: The method of any of embodiments 33 to 35 wherein the SoR information further comprises validity information that indicates a time during which the SoR information is valid.

Embodiment 38: The method of any of embodiments 33 to 35 wherein the SoR information further comprises validity information that indicates a geographic area in which the SoR information is valid.

Embodiment 39: A network node adapted to perform the method of any of embodiments 1 to 38.

Embodiment 40: A method performed by a wireless communication device (114), the method comprising: receiving (320; 420) a message from a Network Function, NF, (300) of a visited network (102) of the wireless communication device (114), the message comprising Steering of Roaming, SoR, information that comprises a prioritized list of visited (or non-public) networks for the wireless communication device (114), where visited (or non-public) networks comprised in the prioritized list are prioritized based on one or more network slices requested by the wireless communication device (114) and/or one or more network slices to which the wireless communication device (114) is subscribed; and performing (322; 422) one or more actions based on the prioritized list of visited (or non-public) networks.

Embodiment 41: The method of embodiment 40 wherein the SoR information further comprises, for each visited (or non-public) network comprised in the prioritized list, information that indicates one or more network slices supported by the visited (or non-public) network.

Embodiment 42: The method of embodiment 40 wherein the SoR information further comprises, for each visited (or non-public) network comprised in the prioritized list, information that indicates one or more network slices of a home network of the wireless communication device (114) that are supported by the visited (or non-public) network.

Embodiment 43: The method of any of embodiments 40 to 42 wherein the SoR information further comprises validity information that indicates one or more conditions under which the SoR information is valid.

Embodiment 44: The method of any of embodiments 40 to 42 wherein the SoR information further comprises validity information that indicates a time during which the SoR information is valid.

Embodiment 45: The method of any of embodiments 40 to 42 wherein the SoR information further comprises validity information that indicates a geographic area in which the SoR information is valid.

Embodiment 46: The method of any of embodiments 40 to 45 further comprising: sending (306), to the NF (300), a registration request message comprising: (a) information that indicates one or more capabilities of the wireless communication device (114) related to enhanced SoR information, (b) information that indicates a geographic location of the wireless communication device (114), (c) information that indicates the one or more network slices requested by the wireless communication device (114), or (d) a combination of any two or more of (a)-(c); wherein receiving (320) the message comprising the SoR information comprises receiving (320) a registration accept message from the NF (300) comprising the SoR information.

Embodiment 47: The method of any of embodiments 40 to 45 further comprising: sending (306), to the NF (300), a message comprising: (a) information that indicates one or more capabilities of the wireless communication device (114) related enhanced SoR information, (b) information that indicates a geographic location of the wireless communication device (114), (c) information that indicates the one or more network slices requested by the wireless communication device (114), or (d) a combination of any two or more of (a)-(c).

Embodiment 48: The method of any of embodiments 40 to 45 further comprising, as part of a UE configuration update procedure, sending (408), to the NF (300), an UL NAS transport message comprising: (a) information that indicates one or more capabilities of the wireless communication device (114) related to its ability to handle a list of prioritized visited (or non-public) networks, (b) information that indicates a geographic location of the wireless communication device (114), (c) information that indicates the one or more network slices requested by the wireless communication device (114), or (d) a combination of any two or more of (a)-(c).

Embodiment 49: A method comprising:
at a wireless communication device (114):
   sending (502), to a first Network Function, NF, (300) in a visited (or non-public) network (102) of the wireless communication device (114), a registration request that comprises: (a) information that indicates one or more capabilities of the wireless communication device (114) related to its ability to handle a list of prioritized visited (or non-public) networks, (b) information that indicates a geographic location of the wireless communication device (114), (c) information that indicates the one or more network slices requested by the wireless communication device (114), or (d) a combination of any two or more of (a)-(c);
at the first NF (300):
   receiving (502) the registration request; and
   initiating a procedure by which one or more policies are derived for the wireless communication device (114) based on the information comprised in the registration request and sent to the wireless communication device (114); and
at the wireless communication device (114):
   receiving (510) the one or more policies;
   using (512) the one or more policies to decide whether to:
      reselect to another visited (or non-public) network in order to access one or more network slices (e.g., one or more requested network slices and/or one or more subscribed network slices), or
      additionally register to another visited (or non-public) network in order to access at least one network slice (e.g., at least one requested or subscribed network slice) while also maintaining a current registration with the visited (or non-public) network.

Embodiment 50: The method of embodiment 49 wherein the one or more polices comprise a network ID to which each of one or more rules (e.g., one or more URSPs) is applicable.

Those skilled in the art will recognize improvements and modifications to the embodiments of the present disclosure. All such improvements and modifications are considered within the scope of the concepts disclosed herein.

1. A method performed in a cellular communications system, the method comprising:
at a first Network Function, NF, in a home network of a wireless communication device roaming in a visited network:
obtaining from the wireless communication device, via a second NF, information comprising capability of the wireless communication device to support Steering of Roaming, SoR, information;
sending to a third NF a request to obtain the SoR information for the wireless communication device;
receiving the SoR information comprising a prioritized list of visited or non-public networks for the wireless communication device, where visited or non-public networks comprised in the prioritized list are prioritized based on
one or more network slices requested by the wireless communication device and/or
one or more network slices to which the wireless communication device is subscribed,
the request comprising an identifier of the visited network and the one or more subscribed network slices of the wireless communication device,
sending, to a second NF in a visited or non-public network of the wireless communication device, a message comprising the received SoR information;
at the second NF:
receiving the message comprising the SoR information; and
sending a message to the wireless communication device comprising the SoR information; and
at the wireless communication device:
receiving the message from the second NF; and
performing one or more actions based on the SoR information.

2. The method of claim 1 wherein the SoR information further comprises, for each visited or non-public network comprised in the prioritized list, information that indicates one or more network slices supported by the visited or non-public network.

3. The method of claim 1 wherein the SoR information further comprises, for each visited or non-public network comprised in the prioritized list, information that indicates one or more network slices of a home network of the wireless communication device that are supported by the visited or non-public network.

4. The method of claim 1 wherein the SoR information further comprises validity information that indicates one or more conditions under which the SoR information is valid.

5. The method of claim 1 wherein the SoR information further comprises validity information that indicates a time during which the SoR information is valid or a geographic area in which the SoR information is valid.

6. (canceled)

7. (canceled)

8. The method of claim 1 wherein the SoR information is comprised in a transparent container such that the SoR information is transparent to the second NF.

9. The method of claim 1 wherein:
at the first NF, obtaining the SoR information comprises:
sending, to a third NF in the home network of the wireless communication device, a request comprising:
(a) a geographic location of the wireless communication device,
(b) information that indicates the one or more network slices requested by the wireless communication device,
(c) information that indicates the one or more network slices requested by the wireless communication device that are not supported by the visited network or non-public network of the wireless communication device,
(d) information that indicates the one or more network slices to which the wireless communication device is subscribed that are not supported by the visited network or non-public network of the wireless communication device,
(e) information that indicates a capability of the wireless communication device for registration to more than one network,
(f) information that indicates one or more capabilities of the wireless communication devices related to its ability to handle enhanced SoR information,
(g) information that indicates one or more capabilities of the wireless communication device to provide additional information to the network, the additional information including information that indicates one or more network slices requested by the wireless communication device, or
(h) a combination of any two or more of (a)-(i); and
receiving, from the third NF, a response comprising the SoR information.

10. The method of claim 9 further comprising, at the third:
receiving the request from the first NF; and
responsive to receiving the request from the first NF, generating SoR information comprising the prioritized list of visited or non-public networks.

11-21. (canceled)

22. A method performed by a first Network Function, NF, in a home network of a wireless communication device roaming in a visited network, the method comprising:
obtaining from the wireless communication device, via a second NF, information comprising capability of the wireless communication device to support Steering of Roaming, SoR, information;
sending to a third NF a request to obtain the SoR, information for the wireless communication device;
receiving the SoR information comprising a prioritized list of visited or non-public networks that are prioritized based on
one or more network slices requested by the wireless communication device and/or
one or more network slices to which the wireless communication device is subscribed,
the request comprising an identifier of the visited network and the one or more subscribed network slices of the wireless communication device, and
sending, towards the wireless communication device, a message comprising the received SoR information.

23. The method of claim 22 wherein the SoR information further comprises, for each visited or non-public network comprised in the prioritized list, information that indicates one or more network slices supported by the visited or non-public network.

24. The method of claim 22 wherein the SoR information further comprises, for each visited or non-public network comprised in the prioritized list, information that indicates one or more network slices of a home network of the wireless communication device that are supported by the visited or non-public network.

25. The method of claim 22 wherein the SoR information further comprises validity information that indicates one or more conditions under which the SoR information is valid.

26. The method of claim 22 wherein the SoR information further comprises validity information that indicates a time during which the SoR information is valid or indicates a geographic area in which the SoR information is valid.

27-30. (canceled)

31. The method of claim 22 further comprising receiving, via the second NF in the visited network or non-public network in which the wireless communication device is currently located, a transparent container comprising information that indicates: the one or more network slices requested by the wireless communication device, a location of the wireless communication device, or a combination of any one or more of (i)-(ii).

32-52. (canceled)

53. The wireless communication device of claim 68 wherein the SoR information further comprises, for each visited or non-public network comprised in the prioritized list, information that indicates one or more network slices supported by the visited or non-public network.

54. The wireless communication device of claim 68 wherein the SoR information further comprises, for each visited or non-public network comprised in the prioritized list, information that indicates one or more network slices of a home network of the wireless communication device that are supported by the visited or non-public network.

55. The wireless communication device of claim 68 wherein the SoR information further comprises validity information that indicates one or more conditions under which the SoR information is valid.

56. The wireless communication device of claim 68 wherein the SoR information further comprises validity information that indicates a time during which the SoR information is valid.

57. (canceled)

58. The wireless communication device of claim 68 wherein the processing circuitry is further configured to:
send, to the NF, a registration request message comprising: information that indicates one or more capabilities of the wireless communication device related to enhanced SoR information, information that indicates a geographic location of the wireless communication device, information that indicates the one or more network slices requested by the wireless communication device, or a combination of any two or more of (a)-(c);
wherein the requested message comprising the SoR information corresponds to a registration accept message from the NF comprising the SoR information.

59-67. (canceled)

68. A wireless communication device comprising:
one or more transmitters;
one or more receivers; and
processing circuitry associated with the one or more transmitters and the one or more receivers, the processing circuitry configured to cause the wireless communication device to:
provide an information container to a second network function, NF, via a first NF of a visited network, the information container comprising a capability of the wireless communication device to receive and handle Steering of Roaming, SoR, information;
receive a message from the first NF of the visited network of the wireless communication device, the message comprising SoR information that comprises a prioritized list of visited or non-public networks for the wireless communication device, where visited or non-public networks comprised in the prioritized list are prioritized based on one or more network slices requested by the wireless communication device and/or one or more network slices to which the wireless communication device is subscribed; and
perform one or more actions based on the prioritized list of visited or non-public networks.
